(19) United States
(12) Patent Application Publication
(10) Pub. No.: US 2009/0022869 A1
(43) Pub. Date: Jan. 22, 2009

(54) ALCOHOLIC BEVERAGE

(76) Inventor: Zvi Chakir, Kfar Shmaryahu (IL)

Correspondence Address: BROWDY AND NEIMARK, P.L.L.C.;624 NINTH STREET, NW, SUITE 300, WASHINGTON, DC, 20001-5303, US

(21) Appl. No.: 11/815,534

(22) PCT Filed: Feb. 2, 2006
(86) PCT No.: PCT/IL2006/000135

§ 371 Date: May 5, 2008

(30) Foreign Application Priority Data
Feb. 3, 2005 (IL) 166672

(51) Int. Cl. C12C 5/02; C12G 3/04; C12G 1/06; C12G 1/00; C12C 5/00

(52) U.S. Cl. 426/569

(57) ABSTRACT

There is disclosed an alcoholic beverage containing three added gases N₂O, CO₂ and O₂ and a method for its preparation. The beverage may further comprise additional flavoring additives.

### FIELD OF THE INVENTION

The present invention relates to novel alcoholic beverages containing dissolved gases.

### BACKGROUND OF THE INVENTION

Gaseous are frequently added to beverages in order to increase the consumer appeal. The most common added gas is carbon dioxide (CO₂) serving the basis of all carbonated beverages. The addition of CO₂ (carbonation) causes foaming upon pouring the beverage from the container. The consumed CO₂ causes in the mouth a variety of sensory impressions. Carbonated beverages include also alcoholic beverages that include bubbles of carbon dioxide. Examples of such alcoholic beverages are beer, and Champaign. The effect of alcoholic beverages on people is also known, where their consumption may cause dizziness, high feeling, and the like. Carbonation of beer is known to cause a bitter by-taste, which is disliked by some consumers, however, found favorable by others. As an alternative to the carbonation of beer and in order to achieve foaming while masking the bitter taste, it is known to add nitrogen (N₂) which causes the beer to be smoother and some what have a less bitter taste. Nitrous oxide (N₂O) is a colorless, sweet-tasting gas which is slightly soluble in water and soluble in alcohol. Likewise, N₂O may also be added as a foaming gas, where N₂O is also known to take away the bitter taste associated with the introduction of CO₂.

WO99/02406 describes a method of producing a liquid product packed in a suitable container where the liquid contains one or more of nitrogen (N₂), CO₂, and N₂O. In particular it relates to a beer having a smoother, non-bitter taste and excellent foaming characteristics. According to this document, the principle purpose of nitrous oxide is to take away the bitterness of the dissolved carbon dioxide.

It is also known in the art to include oxygen in drinking water. Drinking such water lowers tiredness, improves mental clarity, and strengthens the immune system. WO 02/14210 discloses beverages comprising one gaseous additive selected from O₂, CO₂ or N₂O where the container accommodating the beverage comprises a gas-absorbing material capable of storing a quantity of the gas and releasing it into the container upon depletion of the pressure within the container.

### SUMMARY OF THE INVENTION

The present invention provides novel beverages containing alcohol and a combination of three gases, either not naturally present in the beverage or present therein in only relatively small quantities, and being thus artificially added to the beverages. The beverages according to the present invention include any alcohol containing beverage either naturally containing alcohol or artificially fortified with alcohol. Naturally containing alcohol beverages are wine, beer, champagne, vodka, gin or whisky. Beverages fortified with alcohol include any natural or non-natural beverage such as milk-based beverages, fruit-based beverages, and the like into which alcohol was added at the desired concentration.

Numerical values that are given herein should be understood as being approximations and represent a value with the range of 80% to 120% of the one indicated. Thus, for example, “15%” refers in fact to 12% to 18%.

Thus the present invention provides an aqueous-based beverage containing alcohol, and 3 supplemented gases: carbon dioxide (CO₂), oxygen (O₂), and nitrous oxide (N₂O). The term “supplemented gas” should be understood as meaning that the gas, which does not normally exist in the beverage or exist only in small quantities, is added to the beverage. The beverage is occasionally supplemented with two and at times with there of these gases.

According to one embodiment, alcohol and the three gases are added at the appropriate amounts into an aqueous based beverage. According to another embodiment, the three gases at the appropriate amounts are added to an alcoholic beverage. According to a further embodiment, (O₂), and (N₂O) at the appropriate amounts are added to an alcoholic beverage containing CO₂.

The alcohol content of the beverage is typically between the range of about 4% (w/v) to about 15% (w/v) alcohol. The introduced gases consist of N₂O preferably at an amount of at least about 55% (v/v) to preferably about 90% (v/v) of the total; O₂ preferably at an amount of at least about 2% (v/v) to preferably about 20% (v/v); and CO₂ preferably at an amount of at least about 5% (v/v) to preferably about 20% (v/v).

Thus the present invention in particular relates to a milk-based beverage or fruit juice beverage into which alcohol and the three indicated gases CO₂, N₂O and O₂ were added. Alternatively, the present invention relates to a carbonated alcoholic beverage such as beer or Champaign where the appropriate amounts of N₂O and O₂ were added. Still yet the present invention is related to wine where the appropriate amounts of CO₂, N₂O and O₂ were added.

The alcoholic beverage fortified with the three indicated gases may further comprise flavoring additives such as lemon, grapefruit, or orange, “Oak Chips®” (American®, Plain®, or Toasted®). The flavoring additives are added at a concentration of about 0.05 to about 0.2% (w/w) of the beverage.

The present invention is further directed to a method for preparing an alcoholic beverage containing a mixture of three gases CO₂, O₂ and N₂O.

According to one embodiment, the method comprises first mixing the three gases, where the mixture consists of N₂O preferably at an amount of at least about 55% (v/v) to preferably about 90% (v/v) of the; the O₂ is preferably at an amount of at least about 2% (v/v) to preferably about 20% (v/v) of the; the CO₂ is preferably at an amount of at least about 5% (v/v) to preferably about 20% (v/v) of the, where the obtained gaseous mixture is introduced into the alcoholic beverage. According to yet another embodiment, each gas in introduced separately where they may be introduced simultaneously or consequently where there is no importance to their sequential order of introduction.

According to yet another embodiment, the invention concerns the introduction of only O₂ and N₂O into an alcoholic beverage containing CO₂ such as beer or Champaign.

The introduction of the gaseous mixture may be done at a low temperature of about −4° C. to about 10° C. or may be done at room temperature. Preferably, gases are introduced at a pressure higher than atmospheric pressure. Typically, the pressure is between about 3 to 10 atmospheres. Such a high pressure is required for increasing the solubility of the gases introduced into the beverage.

### DETAILED DESCRIPTION OF EXEMPLARY EMBODIMENTS

As mentioned above, the present invention concerns an aqueous-based alcoholic beverage containing dissolved therein three gases, CO₂, O₂ and N₂O. The presence of CO₂ in the alcoholic beverage of the invention attributes to the beverage a taste similar to what is expected from a sparkling soft drink beverage. Hence the added CO₂ improves the taste and introduces a unique mouth feel. It has been surprisingly found according to the present invention, that consumption of N₂O provides euphoric feeling upon its drinking. This is quite different from the anesthetic effect nitrous oxide is known to have when inhaled. Furthermore, addition of N₂O to a beverage causes sparkling, similarly to CO₂, but without the sizzling associated with carbonized beverages. Hence the inclusion of N₂O in addition to CO₂ is beneficial not only with regards to the euphoric feelings associated with its consumption but also its sparkling effect is not associated with undesired effects. Consumption of alcohol at moderate amounts is known in the art to cause dizziness, high feeling and/or slight loss of directionality while O₂ is known in the art to cause quite opposite reactions, i.e. lowers tiredness and improves mental clarity. Hence the effect obtained upon their mixture in a single beverage for a combined consumption was quite unexpected.

According to the present invention, the consumption of the beverage having the combination of alcohol, CO₂, O₂ and N₂O was proven to cause a specific euphoric effect, while keeping the consumer “sober”, i.e. having clear mentality.

The alcohol content of the beverage of the invention is preferably at least about 4% (w/v) alcohol, and preferably at most about 15% alcohol. Hence the alcohol contents in the beverage are between that of a common beer having an alcohol contents of about 4% (w/v) to 8% (w/v) and common wine which typically contains about 11% (w/v) to 18% (w/v) alcohol. It should however be noted that one may use alcoholic beverages having a much higher alcohol contents such as whisky, gin or vodka having an alcohol contents of about 40% (w/v) where prior to the introduction of the CO₂, N₂O and O₂ gases, the alcohol contents is adjusted by dilution in water.

The beverages according to the present invention may be prepared in a variety of routes. In case an aqueous based beverage such as a soft drink or a fruit juice is to be fortified with alcohol and the CO₂, N₂O and O₂ gases, the alcohol is first introduced followed by the three gases. The CO₂, N₂O and O₂ gases may be first mixed together to obtain a mixture, which is introduced into the beverage at room temperature or at a temperature from about −1° C. to about 10° C. Alternatively, the added gases may be introduced separately, simultaneously or not.

### EXAMPLES

### Example 1

### Bear Fortified with O₂, CO₂ and N₂O

To a volume of 330 mL bear (alcohol contents of 5% (w/v)) there were added under a pressure of 8 atmospheres 0.5 gr O₂, 3 gr of N₂O and 2 gr of CO₂ at a temperature of 2° C. The cooled beverage was canned and sealed.

### Example 2

### Diluted Vodka Fortified with O₂, CO₂ and N₂O

Vodka (alcohol contents 40%) was diluted with purified water resulting in an alcoholic beverage having alcohol contents of 5.5% (w/v). To 275 mL of the resulting alcoholic beverage there were added 0.415 gr O₂, 2.5 gr of N₂O and 1.65 gr of CO₂ at a temperature of 1° C. The cooled beverage was canned and sealed.

### Example 3

### Diluted Vodka Fortified with O₂, CO₂ and N₂O Flavored with Lemon

To the beverage obtained in Example 2, there were added prior to canning lemon concentrate at a concentration of 0.08% (w/w) of the beverage.

### Example 4

### Diluted Gin Fortified with O₂, CO₂ and N₂O

Gin (alcohol contents 40%) was diluted with purified water resulting in an alcoholic beverage having alcohol contents of 5.5% (w/v). To 275 mL of the resulting alcoholic beverage there were added 0.415 gr O₂, 2.5 gr of N₂O and 1.65 gr of CO₂ at a temperature of 1° C. The cooled beverage was canned and sealed.

### Example 5

### Diluted Gin Fortified with O₂, CO₂ and N₂O Flavored with Lemon

To the beverage obtained in Example 4, there were added prior to canning lemon concentrate at a concentration of 0.08% (w/w) of the beverage

### Example 6

### Diluted Gin Fortified with O₂, CO₂ and N₂O Flavored with Red Grapefruit

To the beverage obtained in Example 4, there were added prior to canning red grapefruit concentrate at a concentration of 0.1% (w/w) of the beverage.

1. An aqueous-based beverage containing alcohol and three supplemented gas selected from CO₂, O₂ and N₂O.

2. The beverage according to claim 1, having an alcohol contents of about 4% (w/v) to about 15% (w/v).

3. An alcoholic beverage according to claim 1, selected from beer, wine, vodka, gin, whisky and/or Champaign.

4. An alcoholic beverage according to claim 1, having a N₂O contents from about 55% (v/v) to about 90% (v/v) of the supplemented gases.

5. An alcoholic beverage according to claim 1, having a O₂ contents from about 2% (v/v) to about 20% (v/v) of the supplemented gases.

6. An alcoholic beverage according to claim 1, having a CO₂ contents from about 5% (v/v) to about 20% (v/v) of the supplemented gases.

7. An alcoholic beverage according to claim 1 further comprising a flavoring agent at a concentration of about 0.05 to about 0.2% (w/w) of the beverage.

8. An alcoholic beverage according to claim 7, wherein the flavoring agent is selected from, lemon, grapefruit, orange.

9. A milk-based beverage comprising alcohol in amount of from about 4% (w/v) to about 15% (w/v), and CO₂, O₂ and N₂O gases wherein the CO₂ is an amount of about 2% (v/v) to about 20% (v/v) of the supplemented gases; the N₂O is an amount of about 55% (v/v) to about 90% (v/v) of the supplemented gases, and the O₂ is an amount of about 5% (v/v) to about 20% (v/v) of the supplemented gases.

10. A fruit juice-based beverage comprising alcohol in amount of from about 4% (w/v) to about 15% (w/v), and CO₂, O₂ and N₂O gases wherein the CO₂ is an amount of about 5% (v/v) to about 20% (v/v) of the supplemented gases; the N₂O is an amount of about 55% (v/v) to about 90% (v/v) of the supplemented gases, and the O₂ is an amount of about 2% (v/v) to about 20% (v/v) of the supplemented gases.

11. A beer beverage comprising N₂O and O₂, wherein N₂O is in the amount of about 55% (v/v) to about 90% (v/v) of the supplemented gases, and O₂ is in the amount of about 2% (v/v) to about 20% (v/v) of the supplemented gases.

12. A Champaign beverage comprising N₂O and O₂, wherein N₂O is in the amount of about 55% (v/v) to about 90% (v/v) of the supplemented gases, and O₂ is in the amount of about 5% (v/v) to about 20% (v/v) of the supplemented gases.

13. A beverage according to claim 9 further comprising a flavoring agent selected from lemon, grapefruit or orange at a concentration of about 0.05 to about 0.2% (w/w) of the beverage.

14. A method for the preparation of an aqueous-based alcoholic beverage comprising introducing into an aqueous based beverage alcohol in an amount of from about 4% (w/v) to about 15% (w/v) and further introducing into the alcoholic beverage three gases CO₂, O₂ and N₂O, wherein N₂O is preferably at an amount of at least about 55% (v/v) to preferably about 90% (v/v) of the supplemented gases; O₂ is preferably at an amount of at least about 5% (v/v) to preferably about 20% (v/v) of the supplemented gases; and CO₂ is preferably at an amount of at least about 5% (v/v) to preferably about 20% (v/v) of the supplemented gases.

15. A method according to claim 14, further comprising adding to the aqueous-based alcoholic beverage a flavoring agent at a concentration of about 0.05 to about 0.2% (w/w) of the beverage.

16. A method according to claim 15, wherein the flavoring agent is selected from lemon, grapefruit, orange.

17. A method according to claim 14 wherein the CO₂, O₂ and N₂O gases are introduced as a mixture.

18. A method according to claim 14 wherein each gas in introduced separately.

19. A method according to claim 18 where the gases are introduced simultaneously

20. A method according to claim 18 wherein the gases are introduced consequently.

21. A method for the preparation of a beer or Champaign beverage comprising adding to the beer or Champaign N₂O and O₂ wherein N₂O is preferably at an amount of at least about 55% (v/v) to preferably about 90% (v/v) of the supplemented gases; O₂ is preferably at an amount of at least about 2% (v/v) to preferably about 20% (v/v) of the supplemented gases.

22. The method according to claim 14, wherein the introduction of the gaseous mixture is done at a low temperature of from about −4° C. to about 10° C., preferably at from about −1° C. to about 6° C.

23. The method according to claim 14 wherein the introduction of the gaseous mixture is done at room temperature.

24. The method according to claim 14 wherein the introduction of the gaseous mixture is done under atmospheric pressure.

25. The method according to claim 14 wherein the introduction of the gaseous mixture is done at a pressure of from about 3 to about 10 atmospheres.
